(19) United States
(12) Patent Application Publication
(10) Pub. No.: US 2024/0355510 A1
(43) Pub. Date: Oct. 24, 2024

(54) TECHNIQUE FOR MARKING A CONDUCTING ELEMENT

(71) Applicant: Phoenix Contact GmbH & Co. KG, Blomberg (DE)

(72) Inventors: Markus KIEFER, Freiburg im Breisgau (DE); Benjamin ABERLE, Dunningen (DE); Daniel GLATZ, Villingen-Schwenningen (DE)

(21) Appl. No.: 18/292,996

(22) PCT Filed: Jul. 25, 2022
(86) PCT No.: PCT/EP2022/070747

§ 371 Date: Jan. 29, 2024

(30) Foreign Application Priority Data
Jul. 30, 2021 (DE) 10 2021 119 898.4

(51) Int. Cl. H01B 13/34; B41J 3/407

(52) U.S. Cl. CPC H01B 13/345; B41J 3/40733

(57) ABSTRACT

A device for a circumferentially closed arrangement of a printed piece of tubing around a prolate object includes: a guide passage for conveying the piece of tubing along a longitudinal direction thereof and to open piece of tubing during a conveying movement under an effect of flexing forces; and at least one sensor aligned transversely to the longitudinal direction, the at least one sensor detecting an end of the piece of tubing, which end is trailing during the conveying movement, by exposing the at least one sensor, and detecting the prolate object introduced into the piece of tubing, which is opened, along the longitudinal direction against the conveying movement at an exiting of a trailing end by blocking the at least one sensor.

### CROSS-REFERENCE TO PRIOR APPLICATIONS

This application is a U.S. National Phase application under 35 U.S.C. § 371 of International Application No. PCT/EP2022/070747, filed on Jul. 25, 2022, and claims benefit to German Patent Application No. DE 10 2021 119 898.4, filed on Jul. 30, 2021. The International Application was published in German on Feb. 2, 2023 as WO/2023/006643 under PCT Article 21 (2).

### FIELD

The invention relates to a technique for marking a prolate object, for example a conducting element. In particular, the invention relates to a device and a method for the circumferentially closed arrangement of a printed piece of tubing around a prolate object.

### BACKGROUND

For example, label printers are conventionally used for marking electrical conducting elements, which label printers imprint a label which then has to be manually mounted on the conducting element after printing. Document US 2003/146943 A1 describes a printer which alternately prints and cuts a label.

Furthermore, special printers are known which can be used for conducting element marking. Document US 2004/0211522 A1 describes a machine which winds a pre-printed wrap-around label on a spindle roller around a conducting element. From document US 2008/0073023 A1, a monolithic machine for imprinting and applying wrap-around labels is known.

However, the conventional devices can imprint only certain labels and, if automated application is integrated, then no other print applications are possible with such a device.

Conventionally, a user must manually insert the conducting element to be marked into the device and visually check the position of the inserted conducting element. For example, a demonstration video published by the manufacturer “Brady” of the printer “Winsor A6500” shows a manual insertion movement transversely to the longitudinal direction of the conducting element, after which the label is wrapped around a position of the conducting element determined by the device. The wrapping process is conventionally initiated by the user either manually or via a foot button.

The document WO 1999/56271 A1 describes the opening of a printed heat-shrink tubing to push it onto a conducting element. However, in the conventional technique for opening, there is the possibility that the tubing does not open when the longitudinal edges of the flattened tubing are pressed against by means of jaws, but rather an upper and a lower tubing half bulge in the same direction.

Document WO 2021/069416 A1 describes a device which cuts off a printed heat-shrink tubing and opens it at least at the cut ends in that the heat-shrink tubing is deformed transversely to its longitudinal direction by means of opening rollers. The opening rollers are arranged on opposite sides of a guide passage, the width of which is adjustable in that the opening rollers are mounted on transversely movable carriages.

The communication about the accomplished insertion of the conducting element into the heat-shrink tubing is conventionally carried out manually, for example, by means of a foot button or by a button being pressed by a user, whereby the working cycle of the temporally successive markings of a plurality of conducting elements and thus the productivity is limited. In addition, the inspection is strenuous and can be estimated incorrectly when the lengths of the piece of tubing differs.

### SUMMARY

In an embodiment, the present invention provides a device for a circumferentially closed arrangement of a printed piece of tubing around a prolate object, the device comprising: a guide passage configured to convey the piece of tubing along a longitudinal direction thereof and to open piece of tubing during a conveying movement under an effect of flexing forces; and at least one sensor aligned transversely to the longitudinal direction, the at least one sensor being configured to detect an end of the piece of tubing, which end is trailing during the conveying movement, by exposing the at least one sensor, and to detect the prolate object introduced into the piece of tubing, which is opened, along the longitudinal direction against the conveying movement at an exiting of a trailing end by blocking the at least one sensor.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic embodiment of a device for the circumferentially closed arrangement of a printed piece of tubing around a prolate object in a perspective view;

FIG. 2 shows a schematic embodiment of the device for the circumferentially closed arrangement of a printed piece of tubing around a prolate object in a sectional view transverse to the longitudinal direction of a guide passage of the device:

FIG. 3 shows a schematic embodiment of the device for the circumferentially closed arrangement of a printed piece of tubing around a prolate object in a side view of the guide passage of the device:

FIG. 4 shows a schematic embodiment of the device for the circumferentially closed arrangement of a printed piece of tubing around a prolate object in a plan view; and

FIGS. 5A and 5B show schematic views of a connection of the device for the circumferentially closed arrangement of a printed piece of tubing around a prolate object to a printer which provides the imprinted piece of tubing.

### DETAILED DESCRIPTION

In an embodiment, the present invention provides a technique for marking a prolate object in which productivity can be increased and/or a use can be simplified. Alternatively or additionally, it is the object to provide the object to be identified with a printed piece of tubing at a reproducible end position, even with different lengths and diameters of the piece of tubing.

Exemplary embodiments of the invention are described below with partial reference to the figures.

According to a first aspect, a device for the circumferentially closed arrangement of a printed piece of tubing comprises a prolate object, preferably a conducting element, a guide passage which is designed to convey the piece of tubing along its longitudinal direction and to open it during the conveying movement under the effect of flexing forces. The device further comprises at least one sensor oriented transversely to the longitudinal direction, which sensor is designed to detect an end of the piece of tubing which is trailing during the conveying movement by exposing the sensor and to detect the prolate object introduced into the open piece of tubing along the longitudinal direction against the conveying movement when the sensor emerges at the trailing end by blocking the sensor.

The longitudinal direction of the piece of tubing can correspond to a longitudinal direction of the guide passage.

The conveying of the piece of tubing can open the piece of tubing (for example, in a continuous conveying movement) and arrange the open piece of tubing around the (for example, resting) prolate object in a circumferentially closed manner. For example, the prolate object introduced counter to the conveying movement can rest while the open piece of tubing is conveyed over the prolate object to the circumferentially closed arrangement.

The guide passage may be formed, for example, by two rows of rollers. The conveying movement may comprise a co-rotating rotation of a first row of rollers about parallel axes of rotation. Furthermore, the conveying movement may comprise a concurrent rotation of a second row of rollers about parallel axes of rotation, wherein the parallel axes of rotation of the first row of rollers and the second row of rollers are parallel. The rotational movement of the second row of rollers may be opposite to the rotational movement of the first row of rollers.

A roller of the first row and a roller of the second row (opposite for example in the transverse direction) can in each case be referred to as a pair of rollers, for example, if the two rollers are arranged opposite one another in the guide passage (for example transversely or perpendicular to the longitudinal direction). Being arranged opposite may comprise a same position in the longitudinal direction.

By means of the sensor, a position of the piece of tubing and/or a position of the prolate object within the guide passage and/or relative to one another can be monitored (e.g., measured). By blocking the sensor, a (e.g., predetermined) circumferentially closed arrangement of the piece of tubing around the prolate object can be detected (e.g., recognized). For example, an end position of the piece of tubing or of the prolate object relative to the trailing end can be detected. In response to the detection, the arrangement can be released and/or a further process of marking a prolate object by means of a printed piece of tubing can be initiated.

The prolate object may be a conducting element, a tube, a vessel, or a housing. The conducting element may be a prolate object for conducting signals or substances. The conducting element may be, for example, a prolate object for conducting electrical current and/or electromagnetic radiation (preferably light). The vessel may be a test tube or a sample vial, for example, for receiving and/or transporting a fluid.

The conducting element may comprise one core or two, at least two, three or more cores electrically insulated or optically decoupled from one another. The cores may run parallel to one another or may be twisted with one another (for example in pairs).

The conducting element may be a single, multi-wire, finely stranded and/or extra finely stranded conducting element. The conducting element may be a cable, cable bundle, and/or ribbon cable. The conducting element may be a fiber optics (also: fiber optic cable). The conducting element may be a hose and/or a fluid line.

The conducting element may be a cylindrical body and/or a non-rotationally symmetrical prolate body. The conduction of the signals or substances may be directed along a longitudinal axis of the conducting element and/or run between ends of the conducting element.

Exemplary embodiments of the device can increase a speed of marking the prolate object. Alternatively or additionally, exemplary embodiments of the device can enable a serial marking of a plurality of prolate objects. Furthermore, alternatively or additionally, embodiments of the device can simplify marking the prolate object.

The prolate object may comprise a (for example, electrical and/or optical) conducting element. Alternatively or additionally, the prolate object may comprise a hose, for example a pneumatic hose and/or a hydraulic hose. Furthermore alternatively or additionally, the prolate object may comprise a by the piece cylindrical object, for example a glass tubing and/or an ampoule.

The guide passage may comprise at least one carriage which is movable transversely to the longitudinal direction and each of which has a row of rollers extending in the longitudinal direction is arranged thereon. The piece of tubing can be guided in the longitudinal direction between the row of rollers of one of the at least one carriage and a further row of rollers on one side of the guide passage opposite one of the at least one carriage. The rollers can transmit the flexing forces. Optionally, the further row of rollers may be arranged on a further one of the at least one carriage.

The rollers in a row may have corotating parallel axes of rotation. The axes of rotation of the rows of rollers arranged on a first carriage and on a second carriage may be counter-rotating parallel. In a first embodiment, the first carriage and the second carriage may each be movable transversely to the longitudinal direction.

In a second embodiment, a carriage may be movable with a row of rollers transversely to the longitudinal direction, and a further row of rollers may be arranged so as to be immovable transversely to the longitudinal direction, for example, on an immovable side of the guide passage.

The rollers may be tapered.

The rollers may comprise a concave surface. The concave surface may be substantially parallel to the axis of rotation of the respective roller. The concave surface can also be referred to as tapering of the roller.

The rollers can open the printed tubing, for example, in a flat-pressed or flat-held state of the tubing, by flexing the tubing. The tubing can be opened from a flat state by pointing the rollers at a longitudinal edge of the tubing.

The rollers may bear in pairs against points located perpendicular to the longitudinal direction on the cut printed tubing. The device may furthermore comprise an object-centering unit which is designed to arrange the prolate object, preferably the conducting element, in alignment or coaxially to the cut printed tubing.

For the circumferentially closed arrangement around the prolate object, the rollers may be designed to push the cut printed tubing along the longitudinal direction over the prolate object.

The at least one sensor may comprise a plurality of sensors which are arranged spaced apart from one another along the longitudinal direction and/or along the guide passage. The plurality of sensors may be designed to detect, at a first position along the longitudinal direction, the trailing end of the piece of tubing and at a second position spaced apart from the first position along the longitudinal direction, the exit of the inserted prolate object. The first position and the second position may be sensors that are adjacent in the longitudinal direction.

The at least one sensor or each sensor of the plurality of sensors may be arranged along the longitudinal direction between adjacent rollers of the row of rollers of the at least one carriage and/or between adjacent rollers of the further row of rollers. Optionally, a distance of the sensors adjacent along the longitudinal direction may correspond to a distance of adjacent rollers of the row of rollers of the at least one carriage (for example, of the first carriage and/or of the second carriage).

Alternatively or additionally, a roller of the one row of rollers and a further roller of the further row of rollers can be referred to as a pair of rollers (for example, opposing in the longitudinal direction). Each sensor of the plurality of sensors may be arranged offset from the pair of rollers along the longitudinal direction. For example, a sensor may be arranged along the longitudinal direction between two adjacent pairs of rollers.

Alternatively or additionally, a row of sensors (for example, comprising a transmitter and receiver each) may be offset transversely to the longitudinal direction from the one row of rollers (for example, with regard to the transmitter) and/or the further row of rollers (for example, with regard to the receivers).

The exposing and/or the blocking of the at least one sensor can take place without contact. Alternatively or additionally, the at least one sensor may comprise a light barrier transversely to the longitudinal direction. The at least one light barrier may be a one-way light barrier.

The at least one sensor may in each case comprise a transmitter along the longitudinal direction between adjacent rollers of the row of rollers on the at least one carriage and a receiver along the longitudinal direction between adjacent rollers of the further row of rollers for contactless exposing and for contactless blocking.

The at least one light barrier may comprise an infrared transmitter and an infrared receiver. Alternatively or additionally, the light barrier may comprise an infrared light barrier.

The device may further comprise a control unit. In response to the detection of the trailing end of the piece of tubing and/or the detection of the prolate object exiting at the trailing end, the control unit may be designed to release the prolate object with the piece of tubing arranged circumferentially closed around the prolate object.

For example, the plurality of sensors may comprise a first sensor, a second sensor and a third sensor (for example, in each case opposite pairs of transmitter and receiver) arranged successively in the conveying direction. The control unit may be designed to detect (for example, at a first point in time) the trailing end of the piece of tubing by means of the plurality of sensors when the first sensor is exposed, the second sensor is exposed and the third sensor is blocked, for example, if previously the first sensor was exposed, the second sensor was blocked, and the third sensor was blocked. Alternatively or additionally, the control unit (for example, at a second point in time which follows the first time) can detect the prolate object exiting at the trailing end when the first sensor is exposed, the second sensor is blocked, and the third sensor is blocked.

The enabling of the circumferentially closed arrangement of the piece of tubing around the prolate object may comprise a display of the enabling, preferably by means of an optical and/or acoustic signal. Alternatively or additionally, the enabling of the circumferentially closed arrangement of the piece of tubing around the prolate object may comprise a heating of the piece of tubing for non-positively fastening around the prolate object, preferably a heat-shrinking of the piece of tubing. Furthermore, alternatively or additionally, the release of the circumferentially closed arrangement of the piece of tubing around the prolate object may comprise outputting the circumferentially closed arrangement of the piece of tubing around the prolate object from the guide passage.

The optical signal may comprise a light signal and/or a signal on a display unit. Alternatively or additionally, the acoustic signal may comprise a sound and/or a sound sequence.

The fastening of the piece of tubing and/or the shrinking of the piece of tubing may comprise heating.

The outputting of the circumferentially closed arrangement of the piece of tubing around the prolate object may comprise a conveying movement along the guide passage. Alternatively or additionally, the outputting of the circumferentially closed arrangement of the piece of tubing around the prolate object may comprise a transverse movement (for example, transverse to the longitudinal direction) of the at least one carriage (for example, a first carriage and a second carriage). Due to the transverse movement of the at least one carriage (for example, of the first carriage and of the second carriage), a width of the guide passage can be increased. Alternatively or additionally, the outputting may comprise a non-contact removal of the circumferentially closed arrangement of the piece of tubing around the prolate object from the guide passage.

The control unit may be designed to control a width of the guide passage, for example, depending on a width of the prolate object and/or a width of the piece of tubing.

Alternatively or additionally, the control unit may be designed to control a sensitivity of the at least one sensor, for example, depending on a width of the object and/or a width of the piece of tubing. The sensitivity of the at least one sensor can be controlled so that energy consumption when the sensor is enabled is minimized. Alternatively or additionally, the sensitivity of the at least one sensor may comprise a light intensity and/or a light intensity of at least one light barrier. By means of the control unit, a lower limit of the light intensity and/or the light intensity of the transmitter of the light barrier can be determined, so that the receiver of the light barrier still detects light when the light barrier is exposed. Alternatively or additionally, the light barrier can be blocked below the lower limit of the light intensity and/or the light intensity (for example, with a free viewing axis between the transmitter and the receiver). Alternatively or additionally, the light intensity and/or the light intensity can be determined by a current value of the transmitter of the light barrier.

The sensitivity of the sensor, for example, of the light barrier, can depend on the width of the guide passage. For example, the sensitivity of the sensor can decrease with increasing width of the guide passage and/or the light intensity of the transmitter can increase with increasing width of the guide passage.

The device may further comprise a memory unit which is designed to store a signal received by the at least one sensor. Optionally, the received signal can display a sensitivity of the sensor. Alternatively or additionally, the received signal may comprise a (for example predetermined) position of the trailing end of the piece of tubing. Furthermore, alternatively or additionally, the received signal can indicate a (for example predetermined) position of the inserted prolate object.

In a variant that can be applied to any feature and any embodiment, the device may be designed as an applicator, a front part or an attachment of a printer, in particular a thermal transfer printer. The device may be exchangeable. A plurality of different embodiments of the devices may optionally each be attachable to the same printer.

Embodiments of the device enable a modular system (also: printing system) which can be based on a single printer, for example a table unit, so that this printer can be retrofitted in a short time or a few steps for different marking applications of one or more prolate objects, preferably a conducting element. For example, a user can quickly and simply create a system for assisting in the application of a marking (for example, a label) to the prolate object to be marked, preferably a conducting element to be marked, from a normal or application-unspecific label printer.

The terms application and applying can be interpreted synonymously or interchangeably (preferably as method step). The terms arrangement and arranging can (preferably as method step) be interpreted synonymously or interchangeably herein.

Applying the marking on or at the prolate object (preferably on or at the conducting element) may comprise arranging the marking on or at the prolate object, for example, the conveying movement, which introduces the prolate object into the piece of tubing. The enabling (e.g., a provisioning or the outputting) of the marking arranged around the prolate object (preferably around the conducting element) may comprise cutting (preferably cutting to length) of the printed product (for example, of the imprinted piece of tubing).

According to a second aspect, a system for the circumferentially closed arrangement of a printed piece of tubing around a prolate object, preferably a conducting element, is provided. The system comprises a printer, preferably a thermal transfer printer, which is designed to output a printed piece of tubing as a printed product. The system further comprises a device according to the first aspect, wherein the guide passage is arranged relative to the printer in order to receive the imprinted piece of tubing output by the printer as a printed product.

A print medium of the printer may be a piece of tubing. A length of the piece of tubing as a print medium may be arbitrarily longer or several times longer than the provided printed piece of tubing as a marking. The print medium may be referred to as continuous tubing. The imprinted piece of tubing output by the printer may also be referred to as a printed product. The printed product of the printer may comprise the imprinted piece of tubing. The (printed) marking may comprise the cut-to-length and opened piece of tubing.

The printer can receive an identifier via an interface (e.g., a network interface or a serial interface). The printer may be designed to print the received identifier onto a print medium by means of a printing material. The printing material may comprise an ink ribbon, for example, for thermal transfer printing. The print medium (i.e., a printing substrate or imprinting material) may be a plastic film, for example for heat sealing or sealing, or a heat-shrink tubing. The printed product (for example, the imprinted piece of tubing) may comprise the print medium printed by means of the printing material.

The printer may be a thermal transfer printer. The thermal transfer printer can enable a high-contrast and durable marking. The printer may be a thermal transfer roller printer, for example.

One end of the guide passage may be arranged at an output point of the print medium.

By being able to attach embodiments of the device to a printer that is not specific for the application for a specific application, special printers for the respective application, and the associated costs, can be avoided and/or resources can be used more effectively. For example, a utilization rate of the printer can thereby be increased. The same or further embodiments of the device can reduce a downstream manual effort during the assembly of the imprinting materials at the objects to be marked.

According to a third aspect, a method for the circumferentially closed arrangement of a printed piece of tubing around a prolate object, preferably a conducting element, is provided. The method comprises conveying the piece of tubing along a longitudinal direction of a guide passage. The method further comprises detecting a presence and/or a position of the piece of tubing (for example, a trailing end of the piece of tubing) within the guide passage by means of at least one sensor, preferably by means of at least one light barrier. The method further comprises introducing the prolate object into the guide passage and/or into the piece of tubing along the longitudinal direction. The method further comprises detecting a presence and/or a position of the prolate object (for example, at the position of the trailing end of the piece of tubing) by means of at least one sensor, preferably by means of at least one light barrier. Furthermore, the method comprises enabling the circumferentially closed arrangement of the imprinted piece of tubing around the prolate object in response to detecting the presence and/or position of the piece of tubing around the prolate object based on detecting the presence and/or position of the prolate object.

The imprinting and/or cutting of the piece of tubing may precede the conveying.

The conveying of the piece of tubing may comprise the opening of the (for example, printed and/or cut) piece of tubing and/or the insertion of the prolate object into the open piece of tubing. The conveying of the piece of tubing can open the piece of tubing (for example, in a continuous conveying movement) and arrange the open piece of tubing around the (for example, resting) prolate object in a circumferentially closed manner. For example, the prolate object introduced counter to the conveying movement can rest while the open piece of tubing is conveyed over the prolate object to the circumferentially closed arrangement. Alternatively or additionally, after detecting the trailing end of the piece of tubing, the prolate object can be moved against the conveying movement until the exiting of the prolate object is detected.

The method of the third aspect can be carried out by means of the device of the first aspect and/or by means of the system of the second aspect.

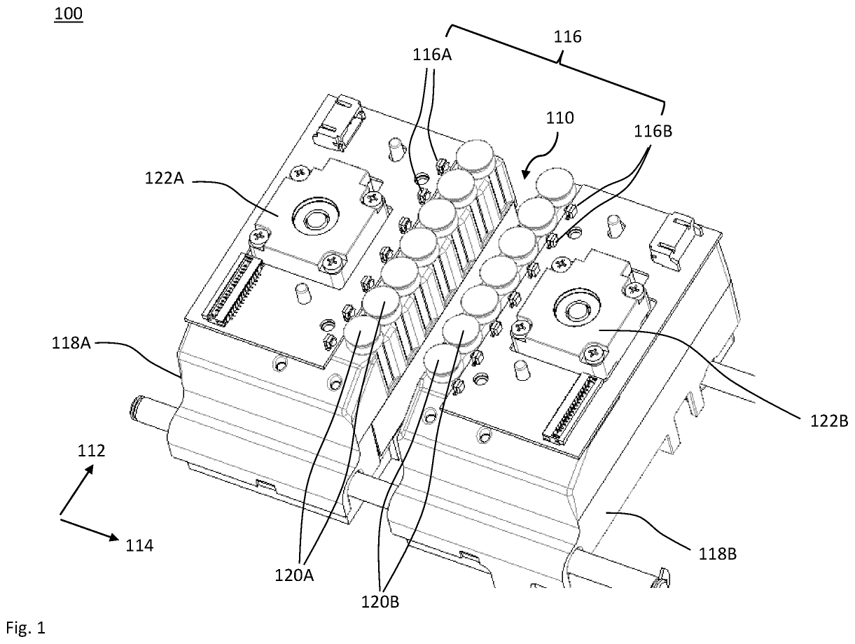

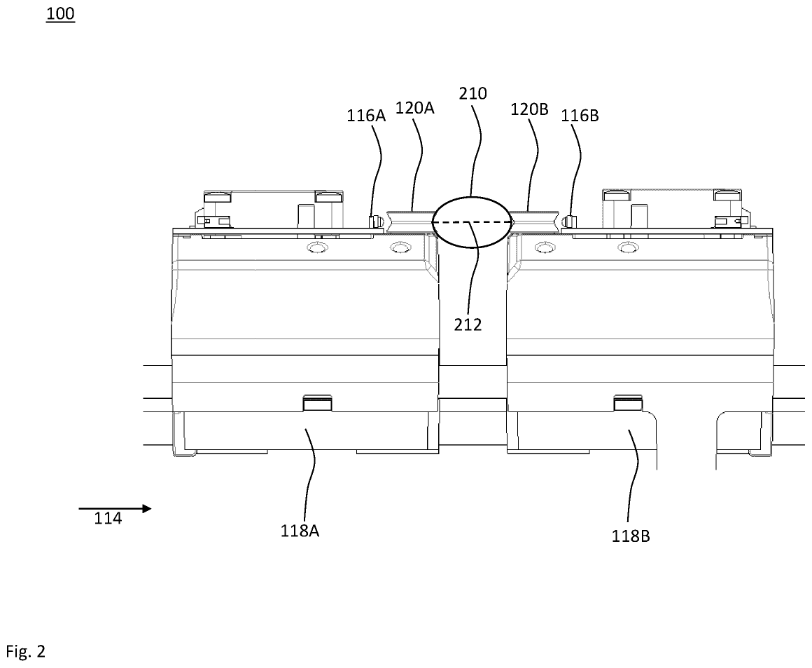

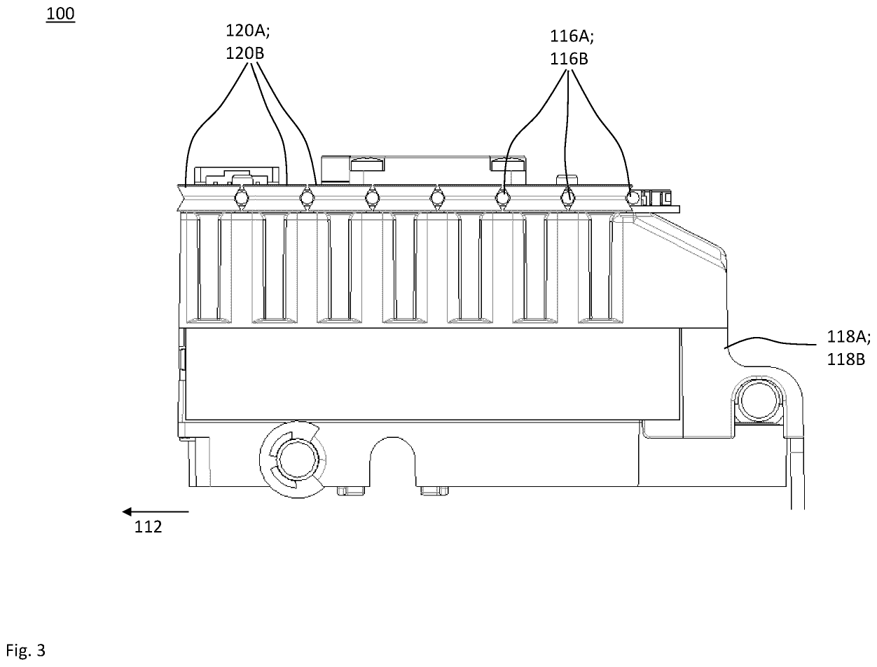

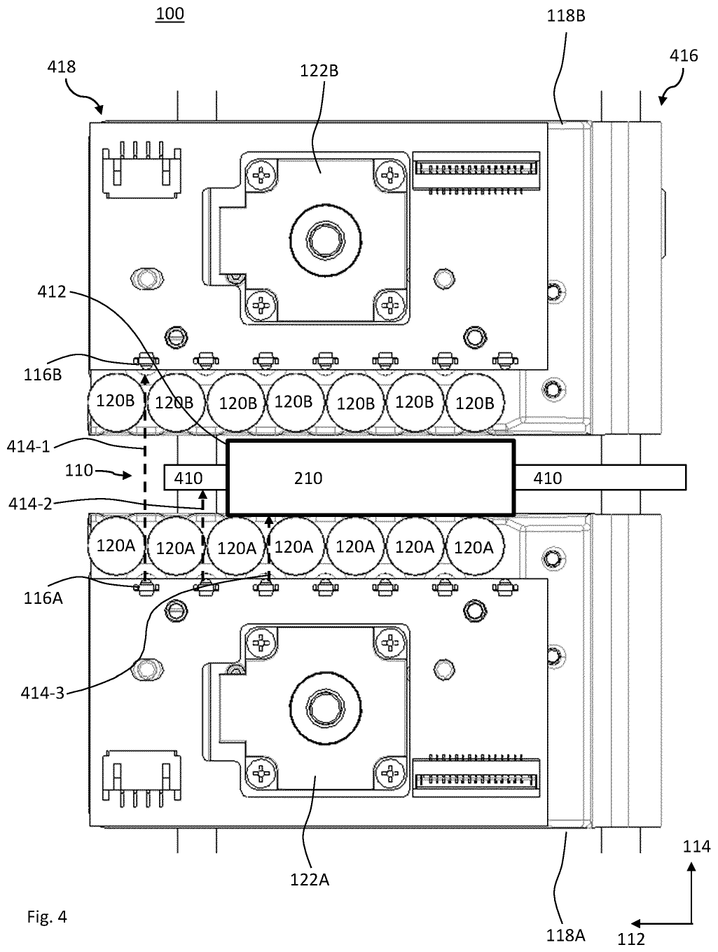

FIGS. 1, 2, 3, and 4 show schematic views of an embodiment of a device generally designated by reference sign 100 (also: “applicator”) for the circumferentially closed arrangement of a printed piece of tubing (also: “heat-shrink tubing”) around a prolate object (also: “medium”). FIG. 1 shows a perspective view of the embodiment of the device 100. FIG. 2 shows a sectional view of the embodiment of the device 100 transversely to the longitudinal axis of a guide passage of the device 100 with a piece of tubing conveyed in the guide passage. FIG. 3 shows a side view along the guide passage. FIG. 4 shows a plan view of the embodiment of the device 100 with a piece of tubing conveyed in the guide passage and an inserted prolate object, for example, a conducting element.

The embodiment of the device 100 shown in FIG. 1 comprises a first carriage 118A (also: “slider”) and a second carriage 118B (also: “slider”), between which a guide passage 110 with a longitudinal direction 112 and transverse direction 114 is formed. A first row of rollers 120A (also: “opening rollers”) is arranged on the first carriage 118A along the longitudinal direction 112 of the guide passage 110. Furthermore, a second row of rollers 120B (also: “opening rollers”) is arranged along the guide passage 110 on the second carriage 118B. In the longitudinal direction 112 between adjacent rollers 120A, a row of transmitters 116A, for example transmitting diodes of a light barrier, of a sensor 116 is arranged on the first carriage 118A. In the longitudinal direction 112 between adjacent rollers 120B, a row of receivers 116B, for example receiving diodes of a light barrier, of a sensor 116 is arranged on the second carriage 118B.

In the embodiment of FIG. 1, the rollers 120A; 120B are each tapered. Opposite pairs of transmitters 116A and receivers 116B can be connected along the transverse direction 114 between pairs of rollers 120A; 120B adjacent in the longitudinal direction 112 (for example, along a line of sight). A pair of rollers 120A; 120B in each case comprises a roller 120A and the roller 120B opposite thereto along the transverse direction 114.

In the embodiment of FIG. 1, the transmitters 116A are connected to a transmitting circuit board 122A on the first carriage 118A. The receivers 116B on the second carriage 118B are connected to a receiving board 122B on the second carriage 118B.

The sensor system comprises the sensors 116 and the transmitting circuit board 122A and the receiving board 122B, which can also be referred to as opposing printed circuit boards. In one embodiment, the transmitting circuit board 122A serves as an infrared light (IR) transmission source. The receiving board 122B comprises receiving electronics and/or evaluation electronics.

In the embodiment shown in FIG. 1, the transmitting circuit board 122A and the receiving board 122B are mechanically positioned on the movable carriages 118A; 118B, between which a printed piece of tubing can be opened.

In the embodiment of FIGS. 1 and 2, the rollers 120A and/or 120B convey the piece of tubing 210 along the guide passage 110. Flexing forces of the rollers 120A; 120B open the piece of tubing, for example, when the piece of tubing 210 has been closed during imprinting or cutting (for example, at one or both ends).

The sectional view of FIG. 2 shows a cross section of the embodiment of the device 100 along the transverse direction 114. The transmitter 116A and the receiver 118A are arranged offset in the transverse direction 114 from the (for example, tapered) rollers 120A and 120B. Along the longitudinal direction 112 (not shown in FIG. 1), transmitters 116A and receiver 116B are arranged between adjacent pairs of rollers 120A and 120B such that a line of sight 212 between the transmitter 116A and the receiver 116B is released.

In other words, a mechanical special feature of the arrangement of the device 100) is that the transmitter 116A and the receiver 116B (for example, a transmitting diode or a receiving diode or phototransistor of a sensor 116) can “look” through the opening rollers in practice in order to detect the piece of tubing and the prolate object fed through (for example, when the sensor 116 is blocked).

FIG. 3 shows the embodiment of the device 100 of FIGS. 1 and 2 in a side view along the longitudinal direction 112 of the guide passage. For example. FIG. 3 shows a side view of the first carriage 118A and/or of the second carriage 118B, wherein the respectively shown side of the carriage 118A; 118B forms one side of the guide passage 110.

FIG. 4 shows the embodiment of the device 100 of FIGS. 1 to 3 in a plan view. FIG. 4 also shows a piece of tubing 210 and an inserted prolate object 410. The piece of tubing 210 is provided by a printer arranged on a printer side 418 (for example, a thermal transfer printer) and conveyed into the guide passage 110. The prolate object 410 is introduced into the piece of tubing 210 from a user side 416 opposite the printer side 418. A first light beam 414-1 and a second light beam 414-2 from adjacent transmitters 116A on the printer side 418 are released by a trailing end 412 of the piece of tubing 210 during or after the conveying process of the piece of tubing 210. A third light beam 414-3 of a third transmitter 116A is blocked by the piece of tubing 210 during or after the conveying process of the piece of tubing 210. An exit of the prolate object 410 at the trailing end 412 of the piece of tubing 210 is detected by blocking the second light beam 414-2. Each light beam 414-1, 414-2, 414-3 can be directed along a line of sight 212 of the associated sensor 116, comprising in each case one transmitter 116A and one receiver 116B.

In one embodiment, the device 100 executes a calibrating (also: “calibration”) of the sensors 116 as soon as tubing parameters of the piece of tubing 210 (for example, a width and/or length of the piece of tubing 210) are transmitted to the device 100 (for example, from the printer) or detected in the device 100. The carriages 118A; 118B are moved to the corresponding distance. A transmit current of the transmitter 116A (for example, IR transmitting diodes) is increased until all corresponding receivers 116B (for example receiving diodes) are released (also: “have switched through”).

By means of the calibration, a functional test of the sensors 116 before the start of each print job and/or each order for marking one or more protracted objects 410 can be carried out. Alternatively or additionally, different distances between the transmitter 116A and the receiver 116B can be compensated for by the calibration at different diameters of the piece of tubing 210. According to one embodiment, the sensors 116 can always be operated with maximum sensitivity.

Alternatively or additionally, energy can be saved by means of the calibration, since, for example, exactly as much transmit current can always be impressed into the transmitters 116A (for example, transmitting diodes), as is actually required. Alternatively or additionally, the calibration can also be used to achieve failure prevention and/or detection of contamination. For example, based on one or more preceding calibrations, it may be known that at a predetermined distance, for example 20 mm, between the transmitter 116A and the receiver 116B of a sensor 116, the required transmit current should be at a predetermined current value, for example 60% (for example, of the maximum current specified for the sensor 116 and/or the transmitter 116A). If the current value determined during the calibration is now above the predetermined current value (for example, above 60%), it can be assumed that there is an error and/or a problem, for example, dirt in the line of sight 212 of the sensor 116 between the rollers 120A; 120B and/or a reduced sensitivity of the receiver 116B, for example, due to aging.

After calibration, the circumferentially closed arrangement (also: “application”) of the piece of tubing 210 around the prolate object 410 can be started. The piece of tubing 210 is conveyed (also: “transported”) between the rollers 120A; 120B from the printer side 418 to the user side 416 (also: “forwards”) and opened (for example, by means of flexing forces transmitted by the rollers 120A; 120B).

The fact that the piece of tubing 210 has reached the front position (for example, relative to the user side 416) is detected via the sensors 116. As a result, slippage occurring during conveying of the piece of tubing 210 can be compensated, and the front end of the piece of tubing 210 and/or the trailing end 412 of the piece of tubing 210 can always be at the same position.

If the piece of tubing 210 has come to a standstill (for example, immediately thereafter) values (for example, an exposing and/or a blocking) of the sensors 116 are read out and/or stored. Reading out and/or storing the values makes it possible to apply piece of tubing with different lengths and/or different widths. For example, the position of the trailing end 412 of the piece of tubing 210 can fluctuate from operation to operation (for example, from marking to marking).

The sensors 116 (for example, the read-out and/or stored values of the sensors 116, in particular, an exposing and/or a blocking of the sensors 116) are continuously checked and the current result is compared to the values which have been stored directly after the standstill of the tubing 210. If a change in the values takes place, for example, the first free sensor 116 (for example, the first free light barrier) downstream of the (in particular, trailing end 412 of the) piece of tubing 210 is interrupted by a prolate object 410 fed through the piece of tubing 210, the blocking of the sensor 116 (for example, the light barrier) is detected and a corresponding reaction is triggered. For example, the circumferentially closed arrangement of the piece of tubing 210 around the procured object 410 is detected and enabled.

The enabling may comprise a display as an optical and/or acoustic signal. Alternatively or additionally, the enabling may comprise heating the piece of tubing 210 for non-positively fastening around the prolate object 410. Furthermore alternatively or additionally, the enabling may comprise outputting the circumferentially closed arrangement of the piece of tubing 210 around the prolate object 410 from the guide passage 110.

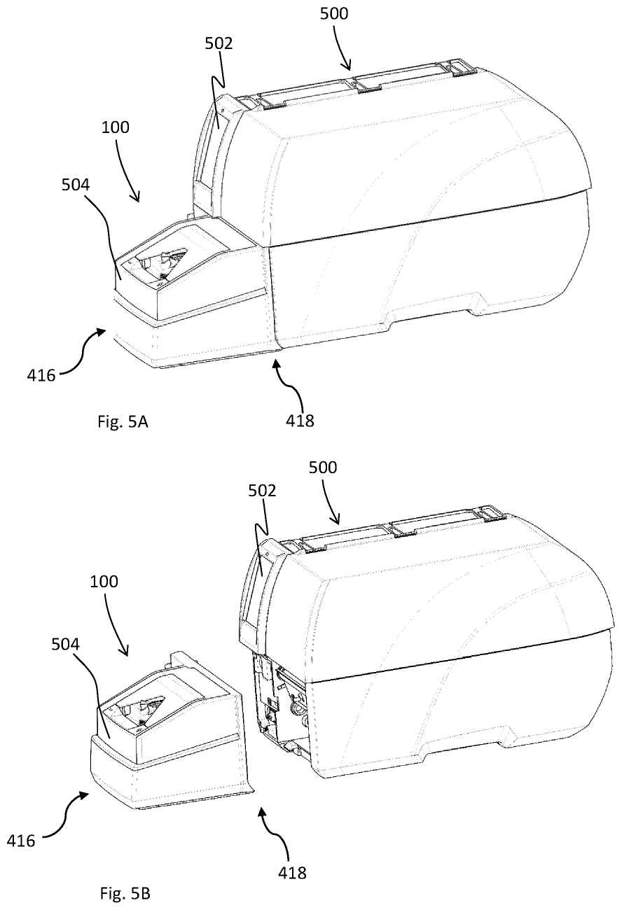

FIGS. 5A and 5B show an arrangement of the device 100 for the circumferentially closed arrangement of an imprinted piece of tubing 210 around a prolate object 410 at a printer 500. In FIG. 5A, the device 100 is connected to the printer 500 (i.e., electrically and/or mechanically connected) to receive the imprinted piece of tubing 210 via the printer side 418 of the device 100. The prolate object 410 can be inserted into the device 100 via the user side 416 of the device 100. FIG. 5B shows the system comprising the device 100 and the printer 500 in an unconnected state of the device 100 and the printer 500.

In FIGS. 5A and 5B, the device 100 is arranged in a housing 504.

The system may comprise a mechanical interface configured to removably fasten the device 100 to the printer 500. Alternatively or additionally, the device 100 comprises a data interface, which is designed to communicate with the printer 500 for the circumferentially closed arrangement (for example, for the application) of the printed, cut and opened piece of tubing 210 as a marking of the prolate object 410.

In the embodiment shown in FIGS. 5A and 5B, the printer 500 comprises a display 502. For example, a state and/or a position of the imprinted piece of tubing 210 (for example, in the device 100) can be displayed on the display 502. Alternatively or additionally, a position of the prolate object 410 in the device 100 can be displayed on the display 502.

As can be seen from the above embodiments, the end of the piece of tubing facing away from a user and/or a further device (which, for example, provides the prolate object) sensors (for example, optical transmitted light sensors) can be monitored via a row of sensors. If a prolate object is now pushed through the piece of tubing from the side facing the user (or the further device) and exist the piece of tubing on the opposing side (for example, at the trailing end of the piece of tubing), the corresponding sensor (for example, transmitted light sensor) is blocked (also: “interrupted”). As a result, the insertion of the prolate object into the piece of tubing is detected, and a process can be continued. For example, a plurality of prolate objects can be marked (for example, in series or non-stop). A productivity and/or a speed of the marking of prolate objects can be increased, and/or use of the device for marking the prolate object by means of a printed piece of tubing can be simplified.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Device 100
Guide passage 110
Longitudinal direction 112
Transverse direction 114
Sensor 116
Transmitter of the sensor 116A
Receiver of the sensor 116B
First carriage 118A
Second carriage 118B
Rollers on the first carriage 120A
Rollers on the second carriage 120B
Transmitting circuit board 122A
Receiver circuit board 122B
Piece of tubing 210
Line of sight 212
Prolate object, for example conducting element 410
Trailing end of the piece of tubing 412
Light beams 414-1; 414-2; 414-3
User side of device 416
Printer side of device 418
Printer, for example thermal transfer printer 500
Display, for example user interface, of printer 502
Housing of the device 504

1. A device for a circumferentially closed arrangement of a printed piece of tubing around a prolate object, the device comprising:
a guide passage configured to convey the piece of tubing along a longitudinal direction thereof and to open the piece of tubing during a conveying movement under an effect of flexing forces; and
at least one sensor aligned transversely to the longitudinal direction, the at least one sensor being configured to detect an end of the piece of tubing, which end is trailing during the conveying movement, by exposing the at least one sensor, and to detect the prolate object introduced into the piece of tubing, which is opened, along the longitudinal direction against the conveying movement at an exiting of a trailing end by blocking the at least one sensor.

2. The device of claim 1, wherein the guide passage comprises at least one carriage which is movable transversely to the longitudinal direction and on which in each case a row of rollers extending in the longitudinal direction is arranged, and
wherein the piece of tubing is guided between the row of rollers of one carriage of the at least one carriage and a further row of rollers on a side of the guide passage opposite the one carriage of the at least one carriage in the longitudinal direction, the rollers being configured to transmit the flexing forces.

3. The device of claim 2, wherein the rollers of the row of rollers are tapered.

4. The device of claim 2, wherein the at least one sensor comprises a plurality of sensors which are arranged spaced apart from one another along the longitudinal direction and/or are arranged along the guide passage.

5. The device of claim 4, wherein the at least one sensor or each sensor of the plurality of sensors is arranged along the longitudinal direction between adjacent rollers of the row of rollers of the at least one carriage and/or between adjacent rollers of the further row of rollers.

6. The device of claim 1, wherein the exposing and/or the blocking of the at least one sensor takes place without contact.

7. The device of claim 1, wherein the at least one sensor comprises a light barrier transverse to the longitudinal direction.

8. The device of claim 6, wherein the at least one sensor comprises in each case a transmitter along the longitudinal direction between adjacent rollers of the row of rollers on the at least one carriage and a receiver along the longitudinal direction between adjacent rollers of the further row of rollers for contact-free exposing and for contactless blocking.

9. The device of claim 7, wherein the at least one light barrier comprises an infrared transmitter and an infrared receiver.

10. The device of claim 1, further comprising:
a control unit configured to release, in response to detection of the trailing end of the piece of tubing and/or detection of the prolate object exiting at the trailing end, the prolate object with the piece of tubing arranged circumferentially closed around the prolate object.

11. The device of claim 10, wherein enabling of the circumferentially closed arrangement of the piece of tubing by the prolate object comprises:
displaying the enabling;
heating the piece of tubing for non-positive attachment around the prolate object; and/or
outputting the circumferentially closed arrangement of the piece of tubing around the prolate object from the guide passage.

12. The device of claim 10, wherein the control unit is configured to control a width of the guide passage depending on a width of the prolate object and/or a width of the piece of tubing.

13. The device of claim 10, wherein the control unit is configured to control a sensitivity of the at least one sensor depending on a width of the prolate object and/or a width of the piece of tubing.

14. The device of claim 1, further comprising:
a memory unit configured to store a signal received from the at least one sensor.

15. A system for circumferentially closed arrangement of a printed piece of tubing around a prolate object, comprising:
a printer, configured to output a printed piece of tubing as a printed product; and
the device of claim 1,
wherein the guide passage is arranged relative to the printer so as to receive an imprinted piece of tubing output by the printer as a printed product.

16. A method for circumferentially closed arrangement of a printed piece of tubing by a prolate object, the method comprising:
conveying the piece of tubing along a longitudinal direction of a guide passage;
detecting a presence and/or a position of the piece of tubing within the guide passage by at least one sensor;
introducing the prolate object into the guide passage and/or into the piece of tubing along the longitudinal direction;
detecting a presence and/or a position of the prolate object by at least one sensor; and
enabling the circumferentially closed arrangement of the imprinted piece of tubing around the prolate object in response to detecting the presence and/or position of the piece of tubing around the prolate object based on detecting the presence and/or position of the prolate object.

17. The device of claim 1, wherein the prolate object comprises a conducting element.

18. The device of claim 2, wherein the further row of rollers is arranged on a further one carriage of the at least one carriage.

19. The device of claim 5, wherein a distance of the sensors adjacent along the longitudinal direction corresponds to a distance of adjacent rollers of the row of rollers of the at least one carriage.

20. The device of claim 11, wherein displaying the enabling is by an optical signal and/or an acoustic signal, and
wherein heating the piece of tubing for the non-positive attachment around the prolate object comprises a heat-shrinking of the piece of tubing.
